(19) United States
(12) Patent Application Publication
(10) Pub. No.: US 2018/0272705 A1
(43) Pub. Date: Sep. 27, 2018

(54) DRIVING WAVEFORM GENERATING DEVICE, LIQUID DISCHARGE HEAD, INKJET RECORDING APPARATUS, AND DRIVING WAVEFORM GENERATING METHOD

(71) Applicant: TOSHIBA TEC KABUSHIKI KAISHA, Tokyo (JP)

(72) Inventors: Shunichi Ono, Izu Shizuoka (JP); Noboru Nitta, Tagata Shizuoka (JP)

(21) Appl. No.: 15/908,908

(22) Filed: Mar. 1, 2018

(30) Foreign Application Priority Data
Mar. 23, 2017 (JP) 2017-057609

(51) Int. Cl. B41J 2/045; B41J 2/14; B41J 23/02

(52) U.S. Cl. CPC B41J 2/04588; B41J 2/04581; B41J 2/14201; B41J 2002/14411; B41J 2/04573; B41J 23/025; B41J 2002/14459; B41J 2/04541

(57) ABSTRACT

In accordance with an embodiment, a driving waveform generating device comprises an input module, a setting module, and a generating module. The input module inputs setting data for setting a driving waveform. The setting module sets an order of waveforms constituting the driving waveform based on the setting data for the driving waveform of each gradation. The generating module generates the driving waveform of a desired gradation based on the setting.

### CROSS-REFERENCE TO RELATED APPLICATION

This application is based upon and claims the benefit of priority from Japanese Patent Application No. 2017-057609, filed Mar. 23, 2017, the entire contents of which are incorporated herein by reference.

### FIELD

Embodiments described herein relate generally to a driving waveform generating device, a liquid discharge head, an inkjet recording apparatus, and a driving waveform generating method.

### BACKGROUND

There is known an inkjet recording apparatus loaded with an inkjet head which discharges liquid from a nozzle. There are known various inkjet recording apparatuses as liquid discharge systems, but as an example, there is known an inkjet recording apparatus using a piezoelectric element. Such an inkjet recording apparatus operates by the application of a driving voltage to the piezoelectric element deforming the piezoelectric element to consequently discharge the liquid. A waveform of the driving voltage applied at this time is generated by combining several basic waveforms. In a conventional inkjet recording apparatus, this combination is defined by a circuit constitution, and cannot be changed except for being changed to a different combination defined in advance.

### DESCRIPTION OF THE DRAWINGS

FIG. 1 is a block diagram illustrating an example of the circuit constitution of the main portions of an inkjet recording apparatus according to an embodiment;

FIG. 2 is a perspective view illustrating an example of an inkjet head shown in FIG. 1;

FIG. 3 is a cross-sectional view of the inkjet head shown in FIG. 2;

FIG. 4 is a longitudinal sectional view of the inkjet head shown in FIG. 2;

FIG. 5 is a block diagram illustrating an example of the circuit constitution of the main portions of a head driver shown in FIG. 1;

FIG. 6 is a flowchart illustrating a control processing by a processor shown in FIG. 1;

FIG. 7 is a diagram illustrating an example of a setting table;

FIG. 8 is a diagram illustrating a driving waveform output from the head driver based on the setting table shown in FIG. 7;

FIG. 9 is a diagram illustrating an example of the driving waveform output from the head driver based on the setting table;

FIG. 10 is a diagram illustrating an example of the driving waveform output from the head driver based on the setting table;

FIG. 11 is a timing diagram illustrating examples of each waveform and each signal flowing in the head driver shown in FIG. 1; and

FIG. 12 is a flowchart illustrating a control processing by the processor shown in FIG. 1.

### DETAILED DESCRIPTION

In accordance with an embodiment, a driving waveform generating device comprises an input module, a setting module, and a generating module. The input module inputs setting data for setting a driving waveform. The setting module sets an order of waveforms constituting the driving waveform based on the setting data for the driving waveform of each gradation. The generating module generates the driving waveform of a desired gradation by combining the waveforms in the order as set above.

Hereinafter, an inkjet recording apparatus according to an embodiment is described with reference to the accompanying drawings. For the sake of explanation, the drawings used for explaining the embodiment show respective sections by appropriately changing the scales thereof in some cases. For the sake of explanation, the drawings used for explaining the embodiment are shown by omitting the constitution in some cases.

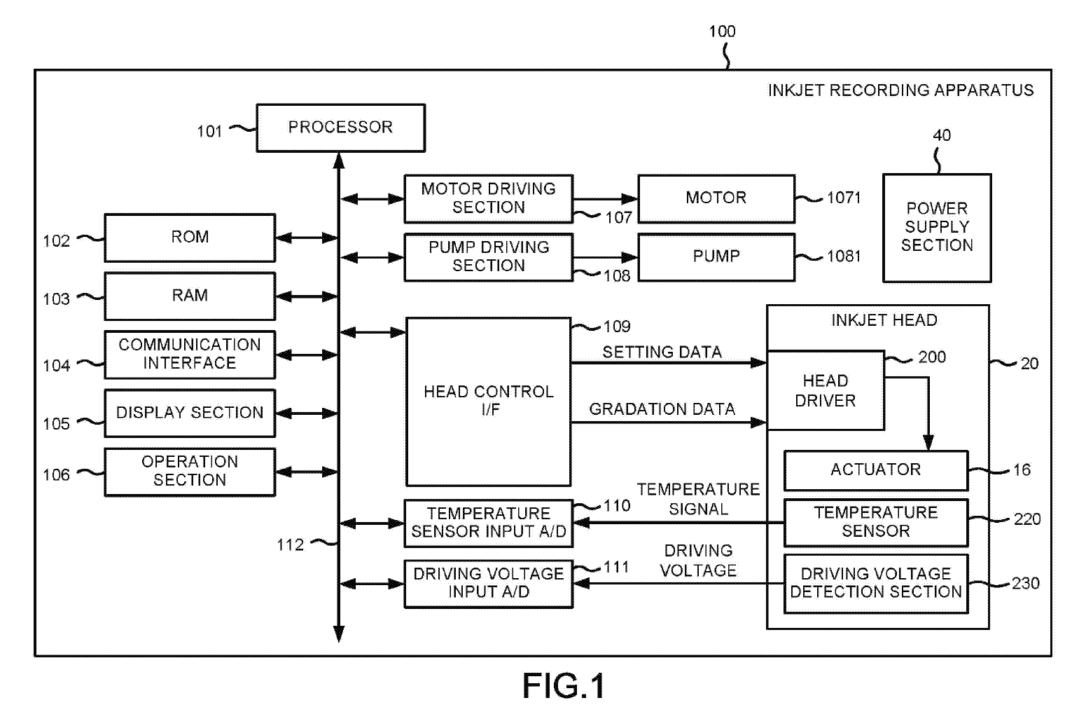

The circuit constitution of the main portions of an inkjet recording apparatus 100 is described. FIG. 1 is a block diagram illustrating an example of the circuit constitution of the main portions of the inkjet recording apparatus 100 according to the embodiment.

The inkjet recording apparatus 100 includes a processor 101, a ROM (read-only memory) 102, a RAM (random-access memory) 103, a communication interface 104, a display section 105, an operation section 106, a motor driving section 107, a motor 1071, a pump driving section 108, a pump 1081, a head control I/F (interface) 109, a temperature sensor input A/D (analog-to-digital) 110, a driving voltage input A/D 111, a bus line 112, an inkjet head 20 and a power supply section 40.

The processor 101 acts as a central part of a computer executing processing and control necessary for the operation of the inkjet recording apparatus 100. The processor 101 controls each section to realize various functions of the inkjet recording apparatus 100 based on an operating system or a firmware control program stored in the ROM 102. The processor 101 is, for example, a CPU (Central Processing Unit), a GPU (Graphics Processing Unit), a MPU (Micro Processing Unit), or a combination thereof. The processor 101 is typically a MPU.

The ROM 102 acting as a main memory portion of a computer with the processor 101 as a center is a nonvolatile memory which is exclusively used for reading data. The ROM 102 stores an operating system or a firmware control program. The ROM 102 stores data used by the processor 101 in executing various processing.

The RAM 103 is a volatile memory acting as a main memory portion of the computer with the processor 101 as the center. The RAM 103 is used as a so-called work area for storing data temporarily used for the processor 101 to execute various processing. The RAM 103 stores a job list which is a list of unprinted print jobs. The print job includes image data of an image which is a printing object or gradation data. The gradation data is used for outputting the driving waveform to the head driver 200.

The operating system or the firmware control program stored in the ROM 102 includes a control program described with regard to a control processing described later. As an example, the inkjet recording apparatus 100 is transferred to an administrator of the inkjet recording apparatus 100 in a state in which the control program is stored in the ROM 102. However, the inkjet recording apparatus 100 may be transferred to the administrator in a state in which the control program described with regard to the control processing described later is not stored in the ROM 102. The inkjet recording apparatus 100 may be transferred to the administrator in a state in which another control program is stored in the ROM 102. The control program described with regard to the control processing described later may be separately transferred to the administrator and written into the ROM 102 under the operation of the administrator or a service person. The transfer of the control program at this time can be realized by recording the control program in a removable storage such as a magnetic disk, a magneto-optical disk, an optical disk, a semiconductor memory or the like, or by downloading the control program via a network.

The communication interface 104 is an interface through which the inkjet recording apparatus 100 communicates with a device such as a PC (personal computer), a server, a tablet PC or a smartphone.

The display section 105 displays a screen for notifying an operator of the inkjet recording apparatus 100 of various information. The display section 105 is, for example, a liquid crystal display, an organic EL (electro-luminescence) display or the like.

The operation section 106 receives an operation by the operator of the inkjet recording apparatus 100. The operation section 106 is, for example, a keyboard, a keypad or a touch pad. As the operation section 106, a touch pad overlaid on a display panel of the display section 105 can also be used. The display panel of the touch panel can be used as the display section 105, and the touch pad of the touch panel can be used as the operation section 106.

The motor driving section 107 is a circuit for driving a motor 1071.

The motor 1071 activates each part of a movable section of the inkjet recording apparatus 100.

One motor driving section 107 and one motor 1071 are shown in FIG. 1, but typically a plurality of the motor driving sections 107 and a plurality of the motors 1071 are provided in the inkjet recording apparatus 100.

The image receiving medium is conveyed, for example, in a sub-scanning direction by driving of the motor 1071. The inkjet head 20 is conveyed, for example, in a main scanning direction by driving of the motor 1071. As a result, the inkjet head 20 is conveyed to a position where the liquid is discharged. Therefore, the motor driving section 107 functions as an example of a conveyance module for conveying the image receiving medium or the inkjet head 20.

The pump driving section 108 is a circuit for driving a pump 1081.

Although one pump driving section 108 and one pump 1081 are shown in FIG. 1, a plurality of the pump driving sections 108 and a plurality of the pumps 1081 may be arranged in the inkjet recording apparatus 100.

The head control I/F 109 includes an interface through which the processor 101 communicates with the inkjet head 20. The head control I/F 109 transmits the setting data and the gradation data to the inkjet head 20 under the control of the processor 101.

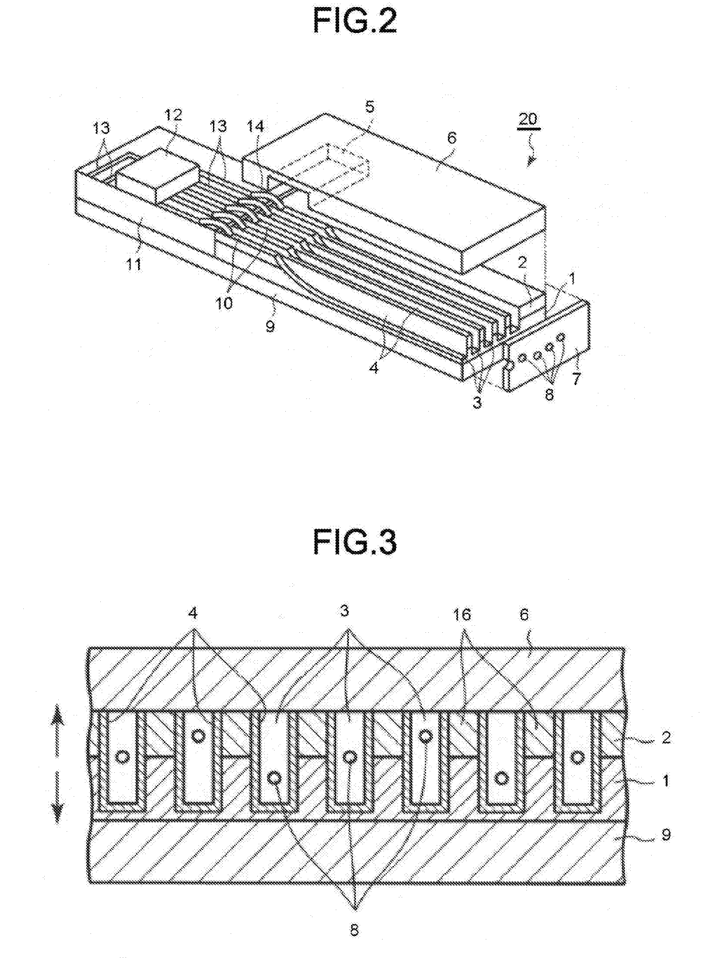

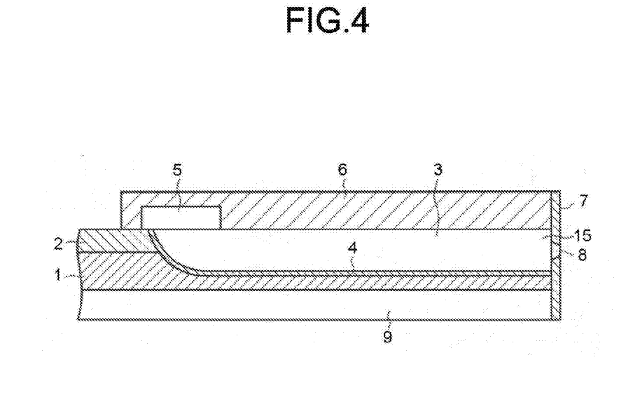

The constitution of the inkjet head 20 is described with reference to FIG. 2 to FIG. 4. FIG. 2 is a perspective view illustrating a part of the inkjet head 20 in a decomposed manner. FIG. 3 is a cross-sectional view of the inkjet head 20. FIG. 4 is a longitudinal sectional view of the inkjet head 20. FIG. 2 to FIG. 4 show a share mode type of the inkjet head 20 as an example.

The inkjet head 20 includes a first piezoelectric member 1, a second piezoelectric member 2, an electrode 4, a top plate 6, an orifice plate 7, a nozzle 8, a base substrate 9, an extraction electrode 10, a printed circuit board 11, a drive IC (Integrated Circuit) 12 and conductors 14. The first piezoelectric member 1 is bonded to the upper surface at a front side of the base substrate 9. The second piezoelectric member 2 is bonded on the first piezoelectric member 1. The bonded first piezoelectric member 1 and second piezoelectric member 2 are polarized in the mutually opposite directions along a plate thickness direction as shown by arrows in FIG. 3.

The base substrate 9 is made from a material which has a small dielectric constant and of which the difference in thermal expansion coefficient from the first piezoelectric member 1 and the second piezoelectric member 2 is small. As the material of the base substrate 9, for example, alumina (Al2O3), silicon nitride (Si3N4), silicon carbide (SiC), aluminum nitride (AlN) or lead zirconic titanate (PZT) is preferable. As the material of the first piezoelectric member and the second piezoelectric member 2, lead zirconic titanate (PZT), lithium niobate (LiNbO3) or lithium tantalate (LiTaO3) is used.

The inkjet head 20 arranges a plurality of long grooves 3 from the front end sides towards the rear end sides of the bonded first piezoelectric member 1 and second piezoelectric member 2. The grooves 3 are arranged with a given interval therebetween and in parallel with each other. The front end of each groove 3 is opened and the rear end thereof is inclined upwards.

The electrodes 4 are arranged on side walls and the bottom of each groove 3. The electrode 4 has a two-layer structure composed of nickel (Ni) and aurum (Au). The electrode 4 is subjected to film formation uniformly in each groove 3 with a plating method. The forming method of the electrode 4 is not limited to the plating method. In addition, a sputtering method or an evaporation method may also be used.

The extraction electrode 10 is arranged from rear end of each groove 3 towards an upper surface of rear side of the second piezoelectric member 2. The extraction electrode 10 extends from the electrode 4.

The top plate 6 seals the top of each groove 3. The orifice plate 7 seals the front end of each groove 3. In the inkjet head 20, a plurality of pressure chambers 15 is formed with the grooves 3 each of which is surrounded by the top plate 6 and the orifice plate 7. The pressure chambers 15, for example, each of which has a depth of 300 μm and a width of 80 μm, are arranged in parallel at an interval of 169 μm. Such a pressure chamber 15 is referred to as an ink chamber.

The top plate 6 includes a common ink chamber 5 at the rear of the inside thereof. In the orifice plate 7, nozzles 8 are threaded at positions opposite to the grooves 3. The nozzles 8 communicate with the grooves 3, i.e., the pressure chambers 15 facing the nozzles 8. The nozzle 8 is formed into a taper shape from the pressure chamber 15 side towards the ink discharge side at the opposite side to the pressure chamber 15 side. The nozzles 8 are formed by being shifted at a given interval in a height direction (vertical direction of paper surface in FIG. 3) of the groove 3 and three nozzles 8 corresponding to the adjacent three pressure chambers 15 are assumed as a set.

The piezoelectric member constituting a partition wall of the pressure chamber 15 is sandwiched between the electrodes 4 provided in the pressure chambers 15 to form the actuator 16. The pressure chamber 15 is contracted and expanded by the operation of the actuator 16.

The printed circuit board 11 is bonded to the upper surface of a rear side of the base substrate 9. Conductive patterns 13 are formed on the printed circuit board 11. On the printed circuit board 11, the inkjet head 20 carries a drive IC 12 in which a head driver 200 described later is mounted. The drive IC 12 is connected with the conductive patterns 13. The conductive patterns 13 are connected with each extraction electrode 10 via conducting wires 14 through a wire bonding.

A set composed of the pressure chamber 15, the electrode 4 and the nozzle 8 included in the inkjet head 20 is referred to as a channel. The inkjet head 20 includes channels ch.1, ch.2, . . . , ch.N, wherein the number of channels is N corresponding to the number of grooves 3.

Referring again to FIG. 1.

The inkjet head 20 includes a head driver 200, a temperature sensor 220, and a driving voltage detection section 230. The inkjet head 20 is an example of the liquid discharge head.

The head driver 200 is a driving circuit for operating the inkjet head. The head driver 200 is, for example, a line driver. The head driver 200 drives a channel group (ch.1, ch.2, . . . , ch.N) of the inkjet head 20 based on the gradation data. The channel group is composed of channels each including the pressure chamber 15, the electrode 4 and the nozzle 8. Based on a control signal from the head driver 200, the channel group discharges ink by the operation of each pressure chamber 15 expanded and contracted by the actuator 16.

The head driver 200 is an example of a driving waveform generating device. The computer with the processor 101 as the center and the head driver 200 cooperate with each other to become an example of the driving waveform generating device.

The temperature sensor 220 measures the temperature inside the inkjet head 20 and outputs a signal indicating the temperature.

The driving voltage detection section 230 outputs the driving voltage waveform of the inkjet head 20.

The temperature sensor input A/D 110 converts a signal output from the temperature sensor 220 to a digital signal. Furthermore, the temperature sensor input A/D 110 transmits the converted digital signal to the processor 101.

The driving voltage input A/D 111 converts the driving voltage waveform output from the driving voltage detection section 230 to a digital signal. Furthermore, the driving voltage input A/D 111 transmits the converted digital signal to the processor 101.

The bus line 112 includes an address bus line, a data bus line, and the like, and transmits signals transmitted and received by each section of the inkjet recording apparatus 100.

The power supply section 40 supplies a power supply voltage to each section of the inkjet recording apparatus 100, such as the inkjet head 20.

The inkjet recording apparatus 100 forms a desired image on the image receiving medium arranged in an opposite manner by performing the ink discharge operation. The image is an example of an object. Therefore, by forming an image, the inkjet recording apparatus 100 functions as a forming module for forming the object.

The inkjet recording apparatus 100 shown in FIG. 1 is an inkjet printer which forms a two-dimensional image by the ink on the image receiving medium, but the inkjet recording apparatus 100 is not limited thereto. The inkjet recording apparatus 100 may be, for example, a 3D printer, an industrial manufacturing machine, a medical machine, or the like. In a case in which the inkjet recording apparatus 100 is the 3D printer, the inkjet recording apparatus 100 forms a three-dimensional object by discharging a binder or the like for solidifying a substance as material or material from the inkjet head 20. The three-dimensional object is an example of the object. Therefore, by forming the three-dimensional object, the inkjet recording apparatus 100 functions as a forming module for forming the object.

FIG. 1 shows one inkjet head 20. However, the inkjet recording apparatus 100 typically includes a plurality of the inkjet heads 20.

A plurality of the inkjet heads 20 discharges ink of plural colors such as cyan ink, magenta ink, yellow ink, black ink, and white ink, respectively, but the colors and characteristics of the used ink are not limited. The inkjet head 20 is also capable of discharging transparent gloss ink, ink which develops color when irradiated with infrared rays or ultraviolet rays, or other special ink. Furthermore, the inkjet head 20 can also discharge the liquid other than the ink. The liquid discharged by the inkjet head 20 may be dispersion liquid such as a suspension. As the liquid other than the ink discharged by the inkjet head 20, for example, liquid containing conductive particles for forming a wiring pattern of a printed wiring assembly, liquid containing cells for artificially forming a tissue or an organ, binder such as adhesive, wax, and liquid resin are exemplified.

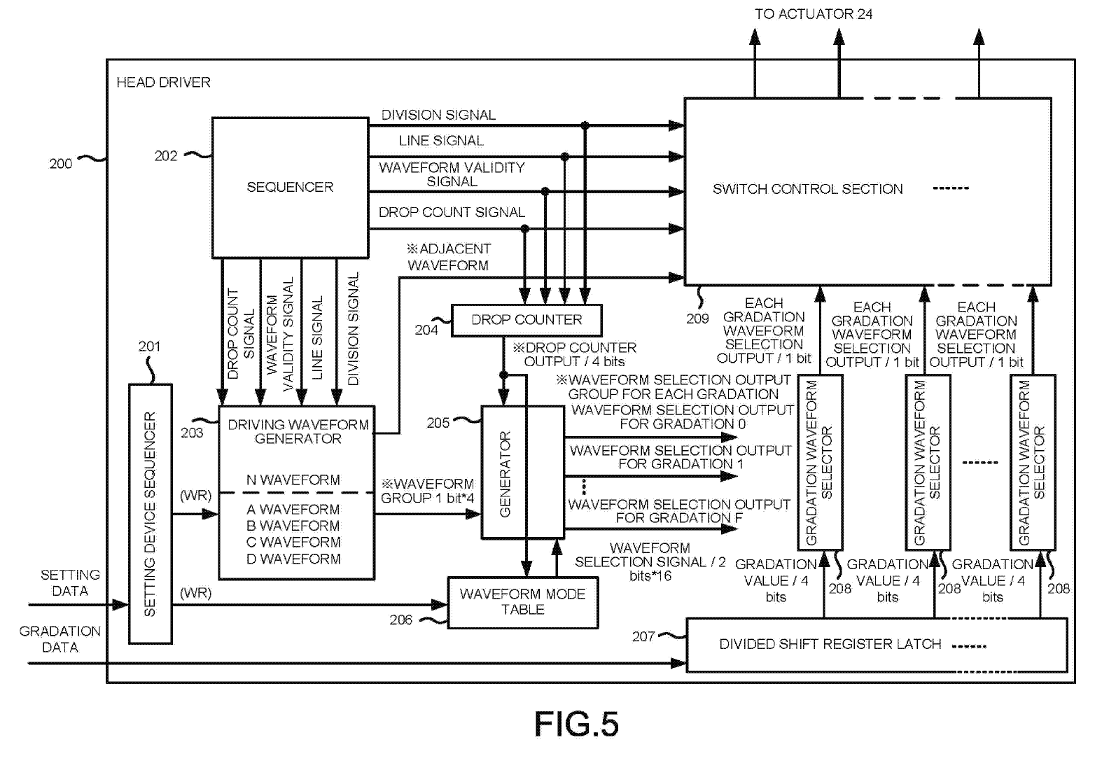

The head driver 200 is further described with reference to FIG. 5. FIG. 5 is a block diagram illustrating an example of the circuit constitution of the main portions of the head driver 200.

The head driver 200 includes a setting device sequencer 201, a sequencer 202, a driving waveform generator 203, a drop counter 204, a generator 205, a waveform mode table 206, a divided shift register latch 207, a gradation waveform selector 208, and a switch controller 209.

The setting device sequencer 201 transfers the setting data to the driving waveform generator 203 and the waveform mode table 206.

The sequencer 202 collectively controls the head driver 200. The sequencer 202 generates synchronization and control signals for each section in the head driver 200 to output them. These signals include, for example, a division signal, a line signal, a waveform signal and a drop count signal.

The driving waveform generator 203 generates a plurality of waveforms necessary for driving the inkjet head 20. The driving waveform generator 203, which is a pattern generator, is rewritable. The waveforms generated by the driving waveform generator 203 are, for example, N waveform, and A waveform to D waveform. Among them, the N waveform is input to the switch controller as an adjacent waveform. Then, the waveforms A to D are input to the generator 205. The A waveform is, for example, a waveform for discharging the ink. The B waveform is, for example, a waveform for vibrating the ink and is also called a boost waveform. The C waveform is, for example, a waveform for performing driving to such an extent that the ink is not discharged. The D waveform is, for example, a waveform for canceling the ink vibration and is also called a damping waveform. Below, waveforms such as A waveform to D waveform generated by the driving waveform generator 203 and input to the generator 205 from the driving waveform generator 203 are collectively referred to as elementary waveforms. The elementary waveforms are examples of waveforms constituting the driving waveform.

The drop counter 204 defines a drop number by performing counting in each drop drive unit for drop column output around one cycle and outputs a predetermined waveform corresponding to the drop number. Drive cycle control is performed by comparing and matching the number of drops currently being driven with the number of drops per predefined cycle.

The generator 205 receives the drop counter output and the waveform selection signal from the waveform mode table, combines the elementary waveforms in the order defined by the table stored in the waveform mode table 206 according to the drop counter to output the combination of the elementary waveforms according to a time axis by the drop count for each gradation value and in parallel for the number of gradations. These output signals are connected in parallel to each gradation waveform selector 208. In FIG. 5, the generator 205 performs the output in parallel for 16 gradations of 0h to Fh. The suffix h in this specification indicates that the numeric value immediately before h is a hexadecimal number.

In the waveform mode table 206, an output order of a plurality of waveforms is defined in response to the drop count for each gradation value, and outputs a waveform selection signal.

The division shift register latch 207 transfers and latches the input gradation data.

Each of the plural gradation waveform selectors 208 corresponds to each of plural actuators 16. The gradation waveform selector 208 selects a corresponding signal among the gradation waveform selection output which is output from the generator 205 based on the latched gradation data and outputs it to the switch controller 209.

According to the gradation waveform selection output selected by the gradation waveform selector 208, the switch controller 209 outputs the driving waveform to each actuator 16 by controlling the high voltage driving switch.

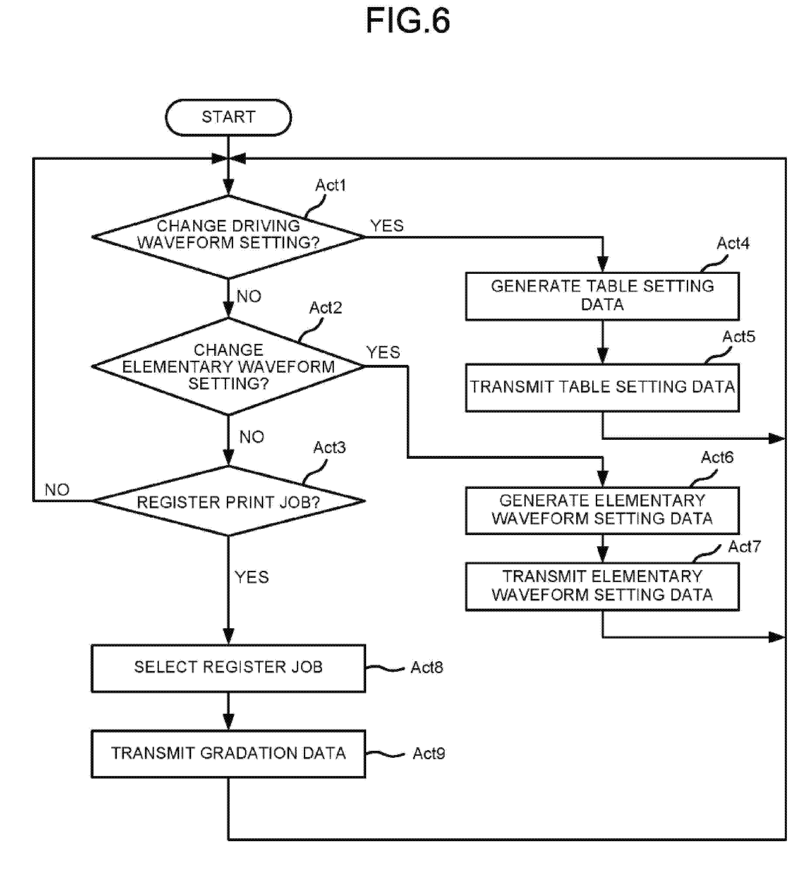

Below, the operation of the inkjet recording apparatus 100 according to the embodiment is described with reference to FIG. 6. The content of the processing in the following operation description is merely an example, and various processing capable of achieving the same result can be appropriately used. FIG. 6 is a flowchart illustrating the control processing by the processor 101 of the inkjet recording apparatus 100. The processor 101 executes the control processing based on the control program stored in the ROM 102.

In Act 1 in FIG. 6, the processor 101 determines whether or not it is instructed to change the setting of the driving waveform. If the processor 101 is not instructed to change the setting of the driving waveform, the processor 101 determines No in Act 1 and proceeds to the processing in Act 2.

In Act 2, the processor 101 determines whether or not it is instructed to change the generation setting of the elementary waveform. If the processor 101 is not instructed to change the generation setting of the elementary waveform, the processor 101 determines No in Act 2 and proceeds to the processing in Act 3.

In Act 3, the processor 101 determines whether or not a print job is registered in the job list. If the print job is not registered in the job list, the processor 101 determines No in Act 3 and returns to the processing in Act 1. Thus, if the print job is not registered in the job list, the processor 101 repeats the processing in Act 1 to Act 3 until the change of the setting of the driving waveform is instructed, the change of the generation setting of the elementary waveform is instructed, or the print job is registered in the job list.

An instruction to change the setting of the driving waveform is, for example, made by an operator of the inkjet recording apparatus 100 who sees a print result of a printed material printed by the inkjet recording apparatus 100 or various numeric values indicating a state of the inkjet recording apparatus 100.

If the processor 101 is instructed to change the setting of the driving waveform in the standby state in Act 1 to Act 3, the processor 101 determines Yes in Act 1 and proceeds to the processing in Act 4. For example, the processor 101 determines that it is instructed to change the setting of the driving waveform if a command to change the setting of the driving waveform is received by the communication interface 104. Alternatively, the processor 101 determines that it is instructed to change the setting of the driving waveform if an operation to change the setting of the driving waveform is performed on the operation section 106.

In Act 4, the processor 101 generates a table setting data for changing the setting of the driving waveform based on the instruction determined in Act 1. The table setting data contains a setting table set in the waveform mode table.

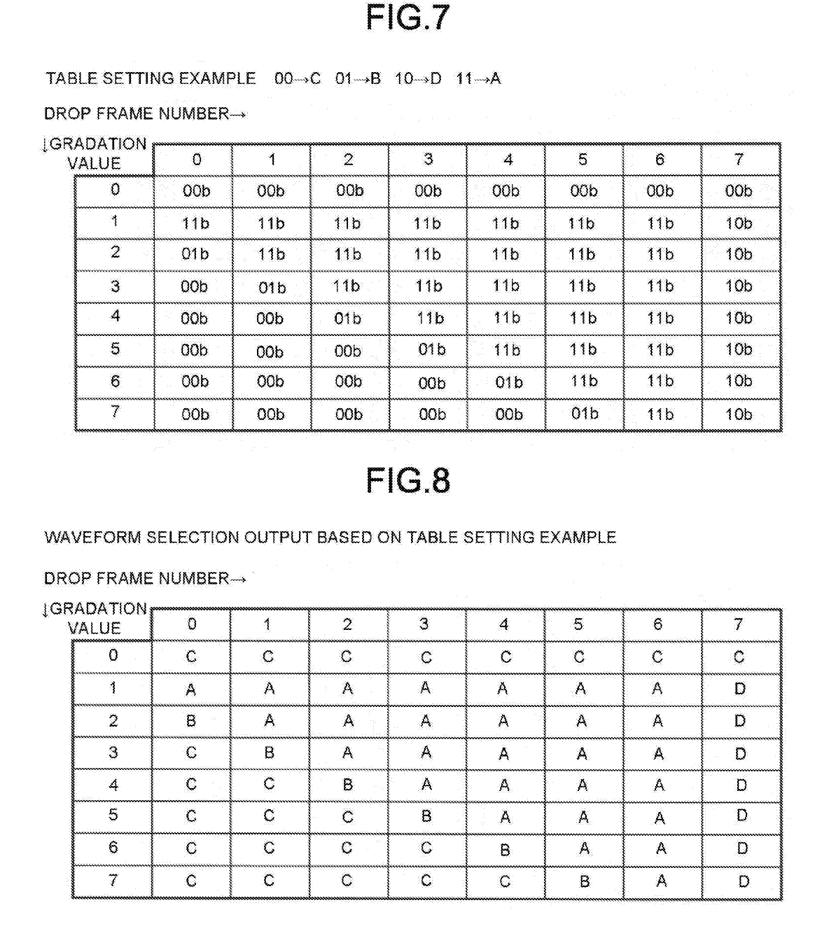

The setting table contained in the setting data is shown in FIG. 7, for example. FIG. 7 is a diagram illustrating an example of the setting table. However, the gradation shown in the setting table in FIG. 7 is set to 8 gradations of 0h to 7h while the gradation shown in FIG. 5 is 16 gradations of 0h to Fh. Similarly, in FIG. 8 to FIG. 10 described later, the gradation is set to 8 gradations as well. In FIG. 7, the driving waveform for one pixel is defined as a combination of eight elementary waveforms corresponding to drop frame numbers 0 to 7 in this order. However, the driving waveform for one pixel is not limited to a combination of eight elementary waveforms, and it may be a combination of the elementary waveforms the number of which is not 8.

00b, 01b, 10b and 11b shown in FIG. 7 are numeric values by binary numbers, and the suffix b indicates that the preceding numeric value is a binary number. As an example, 00b corresponds to the C waveform, 01b corresponds to the B waveform, 10b corresponds to the D waveform, and 11b corresponds to the A waveform. Due to this correspondence relationship, if the setting table shown in FIG. 7 is rewritten, the table shown in FIG. 8 is obtained. FIG. 8 is a diagram illustrating the driving waveform output from the head driver based on the setting table in FIG. 7. The table shown in FIG. 8 shows that A to D waveforms are selected and output in the order of CCCCCCCC for gradation value 0, AAAAAAAD for gradation value 1, BAAAAAAD for gradation value 2, CBAAAAAD for gradation value 3, CCBAAAAD for gradation value 4, CCCBAAAD for gradation value 5, CCCCBAAD for gradation value 6, and CCCCCBAD for gradation value 7.

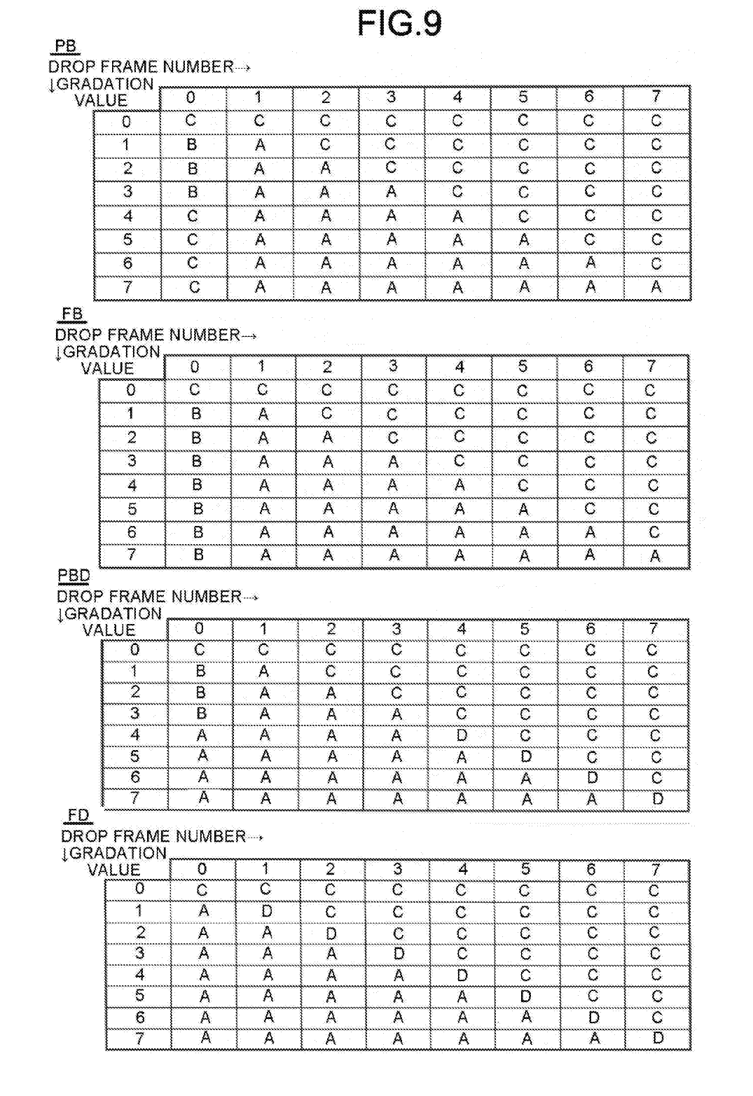

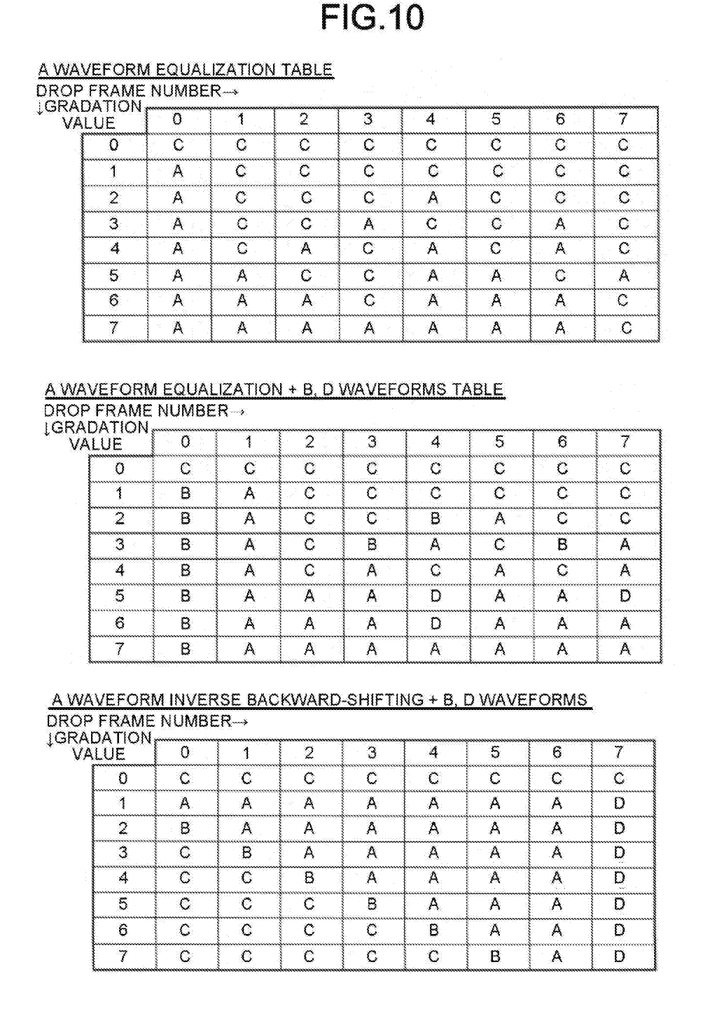

There is no limit to the numeric value of the binary number of each field of the setting table. There is no limitation on the combination manner and the order of A to D waveforms of the driving waveforms output from the head driver. Some examples of the setting table are illustrated in FIG. 9 and FIG. 10. FIG. 9 and FIG. 10 show the numeric values of binary numbers by rewriting them to A to D as shown in FIG. 8.

The PB table shown in FIG. 9 shows that A to D waveforms are selected and output in the order of CCCCCCCC for the gradation value 0, BACCCCCC for the gradation value 1, BAACCCCC for the gradation value 2, BAAACCCC for the gradation value 3, CAAAACCC for the gradation value 4, CAAAAACC for the gradation value 5, CAAAAAAC for the gradation value 6, and CAAAAAAA for the gradation value 7. The PB table shows the driving waveform commonly used.

The FB table shown in FIG. 9 shows that A to D waveforms are selected and output in the order of CCCCCCCC for the gradation value 0, BACCCCCC for the gradation value 1, BAACCCCC for the gradation value 2, BAAACCCC for the gradation value 3, BAAAACCC for the gradation value 4, BAAAAACC for the gradation value 5, BAAAAAAC for the gradation value 6, and BAAAAAAA for the gradation value 7. The driving waveform shown in the FB table first outputs B waveform for all of the gradation values 1 to 7. Therefore, the driving waveform shown in the FB table can be suitably used for heavy ink.

The PBD table shown in FIG. 9 shows that A to D waveforms are selected and output in the order of CCCCCCCC for the gradation value 0, BACCCCCC for the gradation value 1, BAACCCCC for the gradation value 2, BAAACCCC for the gradation value 3, AAAADCCC for the gradation value 4, AAAAADCC for the gradation value 5, AAAAAADC for the gradation value 6, and AAAAAAAD for the gradation value 7.

The FD table shown in FIG. 9 shows that A to D waveforms are selected and output in the order of CCCCCCCC for the gradation value 0, ADCCCCCC for the gradation value 1, AADCCCCC for the gradation value 2, AAADCCCC for the gradation value 3, AAAADCCC for the gradation value 4, AAAAADCC for gradation value 5, AAAAAADC for the gradation value 6, and AAAAAAAD for the gradation value 7.

A waveform equalization table shown in FIG. 10 shows that A to D waveforms are selected and output in the order of CCCCCCCC for the gradation value 0, ACCCCCCC for the gradation value 1, ACCCACCC for the gradation value 2, ACCACCAC for the gradation value 3, ACACACAC for the gradation value 4, AACCAACA for the gradation value 5, AAACAAAC for the gradation value 6, and AAAAAAAC for the gradation value 7. The driving waveform shown in the A waveform equalization table is defined such that the A waveform is distributed relatively evenly. In the PB, FB, PBD and FD tables, the A waveforms are continuous, whereas in the A waveform equalization table, the C waveform is placed between the A waveform and the A waveform.

A waveform equalization+B, D waveforms table shown in FIG. 10 shows that A to D waveforms are selected and output in the order of CCCCCCCC for the gradation value 0, BACCCCCC for the gradation value 1, BACCBACC for the gradation value 2, BACBACBA for the gradation value 3, BACACACA for the gradation value 4, BAAADAAD for the gradation value 5, BAAADAAA for the gradation value 6, and BAAAAAAA for the gradation value 7. In the A waveform equalization+B, D waveforms table, the driving waveform is defined so that the A waveforms are distributed more evenly like the A waveform equalization table. In the A waveform equalization+B, D waveforms table, the driving waveform is defined so as to output the B waveform of the A waveform. Furthermore, in the A waveform equalization+B, D waveforms table, the driving waveform is defined so as to output the D waveform after the A waveform in a case of continuously outputting the A waveforms. However, the present invention is not limited thereto for the gradation value 7.

A waveform inverse gradation backward-shifting+B, D waveforms table shown in FIG. 10 shows that A to D waveforms are selected and output in the order of CCCCCCCC for the gradation value 0, AAAAAAAD for the gradation value 1, BAAAAAAD for the gradation value 2, CBAAAAAD for the gradation value 3, CCBAAAAD for the gradation value 4, CCCBAAAD for the gradation value 5, CCCCBAAD for the gradation value 6, and CCCCCBAD for the gradation value 7. In the PB, FB, PBD, and FD tables, the A waveform is forward-shifted, whereas in the A waveform inverse gradation+B, D waveforms table, the driving waveform is defined so that the A waveform is backward-shifted. In the A waveform inverse gradation+B, D waveforms table, the driving waveform is defined so that the gradation becomes darker as the gradation value decreases, and the gradation becomes lighter as the gradation value increases for the gradation values 1 to 7. In the driving waveform shown in the A waveform inverse backward-shifting+B, D waveforms table, for example, the density of the printed image is inversed.

The processor 101 proceeds to the processing in Act 5 after the processing in Act 4.

In Act 5, the processor 101 instructs the head control I/F 109 to send the table setting data generated in Act 4 to the head driver 200. In response to the instruction, the head control I/F 109 transmits the table setting data to the head driver 200. The transmitted table setting data is received by the setting device sequencer 201 of the head driver 200. The received table setting data is transferred to the waveform mode table 206 by the setting device sequencer 201.The processor 101 returns to the processing in Act 1 after the processing in Act 5. The head driver 200 functions as an input module to input the setting data by receiving the table setting data.

The waveform mode table 206 receiving the transferred table setting data stores the setting table included in the table setting data. By storing the setting table, the waveform mode table 206 functions as a setting module for setting the order of the waveforms constituting the driving waveform based on the setting data for the driving waveform of each gradation.

The instruction to change the generation setting of the elementary waveform is, for example, made by the operator of the inkjet recording apparatus 100 who sees the print result of the printed material printed by the inkjet recording apparatus 100 or various numeric values indicating the state of the inkjet recording apparatus 100.

If the processor 101 is instructed to change the generation setting of the elementary waveform in the standby state in Act 1 to Act 3, the processor 101 determines Yes in Act 2 and proceeds to the processing in Act 6. For example, if the command for changing the generation setting of the elementary waveform is received by the communication interface 104, the processor 101 determines that it is instructed to change the generation setting of the elementary waveform. Alternatively, the processor 101 determines that it is instructed to change the generation setting of the elementary waveform if the operation for changing the generation setting of the elementary waveform is performed on the operation section 106.

In Act 6, the processor 101 generates elementary waveform setting data for changing the generation setting of the elementary waveform based on the instruction determined in Act 2. The processor 101 proceeds to the processing in Act 7 after the processing in Act 6.

In Act 7, the processor 101 instructs the head control I/F 109 to transmit the elementary waveform setting data generated in Act 6 to the head driver 200. Upon receiving this instruction, the head control I/F 109 transmits the elementary waveform setting data to the head driver 200. The transmitted elementary waveform setting data is received by the setting device sequencer 201 of the head driver 200. The received elementary waveform setting data is transferred to the driving waveform generator 203 by the setting device sequencer 201. The processor 101 returns to the processing in Act 1 after processing in Act 7.

The driving waveform generator 203 receiving the transferred elementary waveform setting data changes the waveform of the elementary waveform to be generated based on the elementary waveform setting data.

If the print job is registered in the job list, the processor 101 determines Yes in Act 3 and proceeds to the processing in Act 8.

For example, a print job is registered in the job list as follows. The processor 101 waits for until the print job transmitted by a host PC is received by the communication interface 104. Then, if the print job is received, the processor 101 registers the print job in the job list. The processor 101 waits for until an operation to instruct the printing is executed on the operation section 106. If this operation is performed, the processor 101 registers the content of the printing based on the operation as the print job in the job list. The processor 101 executes the above processing for registering the print job in the job list in a different thread compared with the processing shown in FIG. 6, and processes the above processing concurrently or in parallel with the processing shown in FIG. 6.

In Act 8, the processor 101 selects the print job to be printed next from the job list. Normally, the processor 101 selects the print job first registered in the job list as the print job to be printed next. The processor 101 proceeds to the processing in Act 9 after the processing in Act 8.

In Act 9, the processor 101 instructs the head control I/F 109 to transmit the gradation data included in the print job selected in Act 8 to the head driver 200.

The gradation data included in the print job is generated as follows, for example. First, the host PC divides the printed image data into image data for each used ink. In other words, the host PC divides the printed image data into image data for each ink color such as image data of only cyan component, image data of only magenta component, image data of only yellow component and image data of only black component. Furthermore, the host PC converts the image data for each ink color into serial data. The converted data is the gradation data. In a case in which the gradation data is not included in the print job, the processor 101 may generate the gradation data from the image data included in the print job.

The head control I/F 109 receiving the instruction from the processor 101 transmits the respective gradation data to the head driver 200 of the corresponding ink. The transmitted gradation data is received by the division shift register latch 207 of the head driver 200. The processor 101 returns to the processing in Act 1 after the processing in Act 9. At this time, the processor 101 deletes the print job selected in Act 8 from the job list.

The gradation data received by division shift register latch 207 is divided by the division shift register latch 207 and latched for each gradation waveform selector 208. The latched data is sequentially input to each gradation waveform selector 208 as the gradation value. The gradation waveform selector 208 selects the gradation waveform output from the generator based on the input gradation value. The gradation waveform is the driving waveform. The driving waveform is output through the switch controller 209. By performing the above operation, the head driver 200 functions as a generating module that generates the driving waveform of a desired gradation based on the setting.

The driving waveform output through the switch controller 209 is input to the actuator 16 corresponding to each gradation waveform selector 208. As a result, the actuator 16 is deformed, and the pressure in the pressure chamber 15 varies. As a result, at the time of applying the A waveform, the ink is discharged from the nozzle 8. At the time of applying the B waveform, the amount of vibration of the ink increases. At the time of applying the C waveform, no large change occurs in the ink. At the time of applying the D waveform, the amount of vibration of the ink decreases. Therefore, by applying the driving waveform for one pixel, the ink is discharged from the nozzle 8 for one pixel the number of times corresponding to the number of A waveforms included in the driving waveform.

As described above, if the driving waveform is applied to the actuator 16, the ink is discharged from the nozzle 8. Therefore, the actuator 16 functions as a discharge module for discharging the liquid based on the driving waveform generated by the generating module.

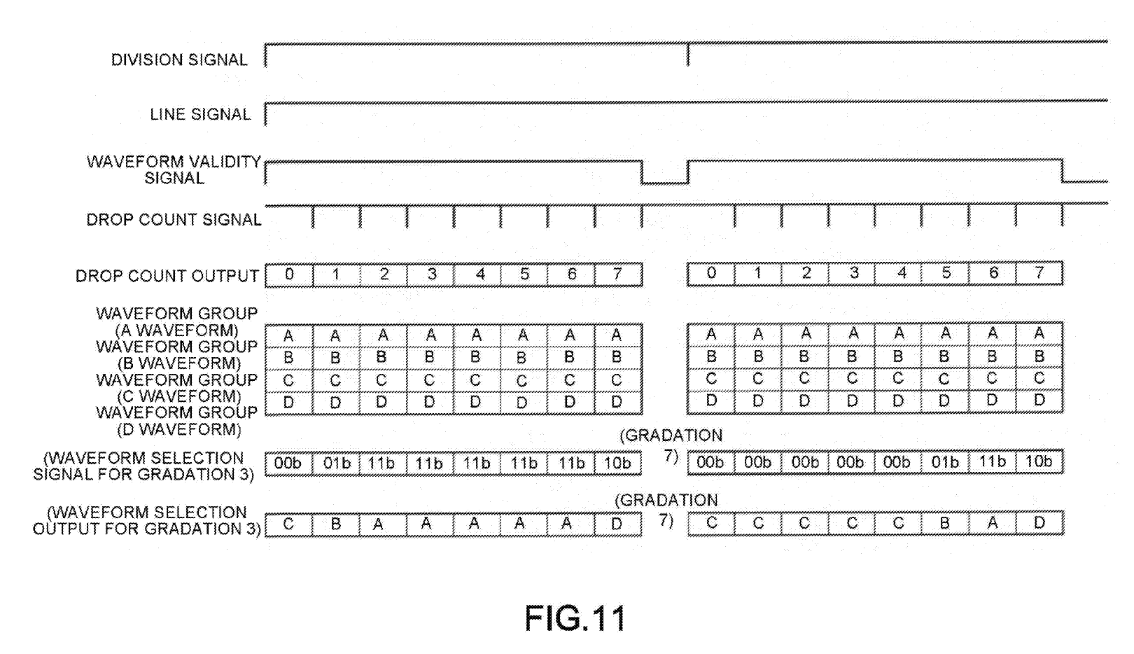

FIG. 11 is a timing chart illustrating each waveform and signal in the head driver in a case in which the driving waveform is output based on the gradation data in which the first gradation value input to the specific gradation waveform selector 208 is 3 and the second gradation value is 7. As in FIG. 7 to FIG. 10, the gradation shown in FIG. 11 is set to 8 gradations from 0h to 7h. In the waveform mode table 206, the setting table shown in FIG. 7 is set.

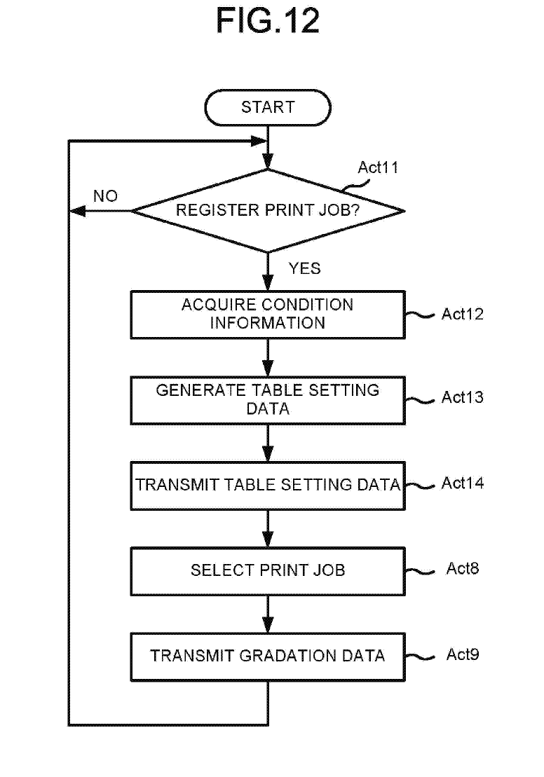

Instead of FIG. 6, the inkjet recording apparatus 100 may perform the operation shown in FIG. 12. Alternatively, the inkjet recording apparatus 100 may selectively execute either of the processing in FIG. 6 and FIG. 12 according to the setting. The content of the processing in the following operation description is merely an example, and various processing capable of achieving the same result can be suitably used. FIG. 12 is a flowchart of the control processing by the processor 101 of the inkjet recording apparatus 100. The processor 101 executes this control processing based on the control program stored in the ROM 102.

In Act 11 in FIG. 12, the processor 101 determines whether or not the print job is registered in the job list in the same manner as the processing in Act 3. If the print job is registered in the job list, the processor 101 determines Yes in Act 11 and proceeds to the processing in Act 12.

In Act 12, the processor 101 acquires information (hereinafter, referred to as “condition information”) used as a condition for determining the setting of the driving waveform. The processor 101 proceeds to the processing in Act 13 after the processing in Act 12. The condition information is, for example, a temperature of the inside of the inkjet head 20. In this case, the processor 101 acquires, for example, a signal output from the temperature sensor input A/D 110 as the condition information. The condition information is, for example, a state of the ink such as viscosity or a specific gravity of the ink in the inkjet head 20. In this case, the processor 101 acquires, for example, a signal output from a sensor (not shown) provided in the inkjet head 20 as the condition information.

In Act 13, the processor 101 generates the table setting data based on the condition information acquired in Act 12. For example, the processor 101 includes the setting table suitable for the condition information in the table setting data according to the acquired condition information. At this time, for example, the processor 101 selects the setting table corresponding to the acquired condition information from a plurality of the setting tables previously stored in the ROM 102 as the setting table included in the table setting data. Alternatively, the processor 101 performs an operation based on a predetermined function based on the acquired condition information and generates the setting table included in the table setting data. The processor 101 proceeds to the processing in Act 14 after the processing in Act 13.

In Act 14, the processor 101 instructs the head control I/F 109 to transmit the table setting data generated in Act 13 to the head driver 200. The head control I/F 109 receiving the instruction transmits the table setting data to the head driver 200. The transmitted table setting data is received by the setting device sequencer 201 of the head driver 200. The received table setting data is transferred to the waveform mode table 206 by the setting device sequencer 201. The processor 101 proceeds to the processing in Act 8 after the processing in Act 14. The head driver 200 functions as the input module for inputting the setting data by receiving the table setting data. The processor 101 proceeds to the processing in Act 8 after the processing in Act 14. By executing the processing in Act 12 to Act 14, the computer with the processor 101 as the center cooperates with the head control I/F 109 to function as an output module for determining the combination of the elementary waveforms of the driving waveform for each gradation based on the conditions, and outputting the determined content as the setting data.

The processor 101 executes the processing in Act 8 and Act 9, and then returns to the processing in Act 11. At this time, the processor 101 deletes the print job selected in Act 8 from the job list.

According to the inkjet recording apparatus 100 of the embodiment, the table recorded in the waveform mode table can be freely changed by inputting the table setting data. Therefore, the degree of freedom of generation of the driving waveform is higher than conventional case. As a result, the boost waveform or the damping waveform can be applied at a desired timing. By changing the table, it is possible to change a tone such as a gamma value or a contrast of the printed image.

Further, according to the inkjet recording apparatus 100 of the embodiment, by inputting the elementary waveform setting data, the waveform of the elementary waveform generated by the driving waveform generator 203 can also be changed. Therefore, the degree of freedom of generation of the driving waveform becomes even higher.

According to the inkjet recording apparatus 100 of the embodiment, the table setting data is generated based on the condition information. Therefore, the driving waveform can be changed according to change in the temperature, the ink state, or the like. As a result, it is possible to change the driving waveform to the suitable driving waveform according to the condition, and improvement of print quality can be expected.

The driving waveform shown in FIG. 9 is capable of being output even by the conventional head driver, but it can also be output by the head driver 200 of the embodiment. The driving waveform as shown in FIG. 10 cannot be output by the conventional head driver, but it can be output by the head driver 200 of the embodiment. In the head driver 200 of the embodiment, both the conventional driving waveform and the driving waveform different from the conventional one are capable of being output.

The above embodiment can also be modified as follows.

In the above embodiment, the combination of the elementary waveforms constituting the driving waveform is set and defined by storing the setting table in the waveform mode table 206. However, a data format stored in the waveform mode table 206 is not limited to the table, and other data formats such as array may also be used as long as combinations of the elementary waveforms constituting the driving waveform can be defined.

The inkjet recording apparatus 100 may execute the processing in Act 12 to Act 14 at a timing other than the timing before printing. For example, the inkjet recording apparatus 100 executes the processing in Act 12 to Act 14 after the printing, i.e., after the processing in Act 9 in FIG. 6 or after the processing in Act 9 in FIG. 12. For example, the inkjet recording apparatus 100 executes the processing in Act 12 to Act 14 at the time of maintenance operation.

The inkjet recording apparatus 100 may change the setting table during the printing. For example, the inkjet recording apparatus 100 acquires the condition information such as the temperature in the printing, and changes the setting table each time based on the acquired condition information. As a result, by changing the setting table, it can be expected to reduce the change in the print quality caused by the temperature change in the printing along with the printing drive.

The inkjet recording apparatus 100 may use the printing result as the condition information. In this case, the inkjet recording apparatus 100 includes a scanner. Then, the inkjet recording apparatus 100 reads an object such as a formed image or a three-dimensional object with the scanner. The inkjet recording apparatus 100 generates the table setting data by evaluating the print quality of the object using the information read by the scanner as the condition information.

Although there are four types of the elementary waveforms of the above embodiment, i.e., A to D waveforms, the number of the types of the elementary waveforms are not limited to four. In the setting table of the above embodiment, 2-bit numeric values of 00b to 11b corresponding to the A waveform to the D waveform are used, but if the number of the types of the elementary waveforms exceeds 4, a numeric value larger than 2 bits is used.

The setting device sequencer 201 may be omitted. In this case, the table setting data is input to the waveform mode table 206 directly without passing through the setting device sequencer 201. The elementary waveform setting data is input directly to the driving waveform generator 203 without passing through the setting device sequencer 201.

The inkjet head may discharge the liquid from the nozzle by deforming a diaphragm with static electricity or discharge the liquid from the nozzle by using a thermal energy of a heater or the like.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A driving waveform generating device, comprising:
an input module configured to input setting data for setting a driving waveform;
a setting module configured to set an order of waveforms constituting the driving waveform based on the setting data for the driving waveform of each gradation; and
a generating module configured to generate the driving waveform of a desired gradation based on the setting.

2. The driving waveform generating device according to claim 1, further comprising:
an output module configured to determine an order of waveforms constituting the driving waveform for each gradation based on the condition and output the determined content as the setting data, wherein
the input module inputs the setting data output by the output module.

3. The driving waveform generating device according to claim 1, wherein the setting data comprises 2-bit numeric values.

4. The driving waveform generating device according to claim 1, wherein the setting data comprises 2-bit numeric values of 4 waveforms.

5. A liquid discharge head, comprising:
an input module configured to input the setting data for setting a driving waveform;
a setting module configured to set an order of waveforms constituting the driving waveform based on the setting data for the driving waveform of each gradation;
a generating module configured to generate the driving waveform of a desired gradation based on the setting; and
a discharge module configured to discharge liquid based on the driving waveform generated by the generating module.

6. The liquid discharge head according to claim 5, further comprising:
an output module configured to determine an order of waveforms constituting the driving waveform for each gradation based on the condition and output the determined content as the setting data, wherein
the input module inputs the setting data output by the output module.

7. The liquid discharge head according to claim 5, wherein the discharge module comprises a piezoelectric element that receives the driving waveform.

8. The liquid discharge head according to claim 5, wherein the discharge module comprises two piezoelectric elements that receive the driving waveform.

9. An inkjet recording apparatus, comprising:
an input module configured to input the setting data for setting a driving waveform;
a setting module configured to set an order of waveforms constituting the driving waveform based on the setting data for the driving waveform of each gradation;
a generating module configured to generate the driving waveform of a desired gradation based on the setting;
a discharge module configured to discharge liquid based on the driving waveform generated by the generating module; and
a conveying module configured to convey an image receiving medium to which the liquid is discharged by the discharge module or a liquid discharge head comprising the discharge module.

10. The inkjet recording apparatus according to claim 9, further comprising:
an output module configured to determine an order of waveforms constituting the driving waveform for each gradation based on the condition and output the determined content as the setting data, wherein
the input module inputs the setting data output by the output module.

11. The inkjet recording apparatus according to claim 9, wherein the discharge module comprises a piezoelectric element that receives the driving waveform.

12. The inkjet recording apparatus according to claim 9, wherein the discharge module comprises two piezoelectric elements that receive the driving waveform.

13. The inkjet recording apparatus according to claim 9, wherein the setting data comprises 2-bit numeric values.

14. The inkjet recording apparatus according to claim 9, wherein the setting data comprises 2-bit numeric values of 4 waveforms.

15. A driving waveform generating method, comprising:
inputting setting data for setting a driving waveform;
setting an order of waveforms constituting the driving waveform based on the setting data for the driving waveform of each gradation; and
generating the driving waveform of a desired gradation based on the setting.

16. The driving waveform generating method according to claim 15, further comprising:
determining an order of waveforms constituting the driving waveform for each gradation based on a condition, and
outputting the determined content as the setting data.

17. The driving waveform generating method according to claim 15, wherein the setting data comprises 2-bit numeric values.

18. The driving waveform generating method according to claim 15, wherein the setting data comprises 2-bit numeric values of 4 waveforms.
